(19) United States
(12) Patent Application Publication
(10) Pub. No.: US 2016/0236927 A1
(43) Pub. Date: Aug. 18, 2016

(54) VENTILATION SYSTEM FOR PETROLEUM SUMP

(71) Applicant: Perry and Sons, LLC, Monroe, LA (US)

(72) Inventor: Michael R. PERRY, Monroe, LA (US)

(21) Appl. No.: 14/621,088

(22) Filed: Feb. 12, 2015

(51) Int. Cl. B67D 7/68

(52) U.S. Cl. CPC B67D 7/68

(57) ABSTRACT

A ventilation system for petroleum dispensing and storage systems.

### FIELD OF THE INVENTION

The field of the invention is petroleum dispensing equipment.

### BACKGROUND

There is a vast body of literature, industry standards and law applicable to the equipment, methods and systems for handling storage and dispensing petroleum products (including, without limitation, gasoline and diesel fuel), but problems and difficulties remain which have not yet been solved. One of these unsolved problems is corrosion of metal components in sumps. Corrosion of metals including iron, copper and other metals occurs naturally by exposure to air. Sumps are required by regulations and are intended to collect liquid fuel and vapor leaking from seals in the sump. Sumps are also designed to provide access to the turbine area above the tank. The turbine area may house a pump head, piping, line leak detectors, interstitial monitoring devices, wiring, and other equipment. Sumps are enclosed areas and trap water and water vapor, as well as fuel which leaks in liquid and vapor form. Rates of corrosion are linked directly to increasing moisture and heat in the sump. Monitors for detecting corrosion and warning a system operator have been proposed recently but monitors, by themselves, would do nothing to prevent or retard the corrosion. Until now there has been no invention for preventing or retarding corrosion, instead of merely warning about it. Current standards, usages, customs or regulations have either prevented or discouraged the means and method proposed herein, so there is a need for a solution which will prevent or retard corrosion and create economic efficiencies and improved safety.

### BRIEF DESCRIPTION OF THE DRAWINGS

FIG. 1 is a schematic overview of an embodiment of active ventilation for the ventilation system with uni-directional flow of air, petroleum vapors and moisture.

FIGS. 2a and 2b depict the interior of a valve used for uni-directional flow of air, petroleum vapors and moisture in open and closed positions, respectively.

### DETAILED DESCRIPTION

The invention herein comprises a system for ventilation of a sump employed in storage and dispensing systems for petroleum which is defined herein as gasoline (with or without ethanol), diesel, kerosene, other fuels and any combination thereof. A sump, as used herein, may be any enclosed space. Ventilation can be achieved in several ways, depending on the particular circumstances and geographic location of the system. The embodiment for passive ventilation, as further described herein, comprises a first pipe and a second pipe and utilizes the free flow of fresh air from the atmosphere above ground into the sump and the outflow of petroleum vapors and moisture. In a passive ventilation embodiment, fresh air, petroleum vapors and moisture can flow bi-directionally depending on a variety of factors including temperature and the concentration gradients between the sump and the atmosphere for petroleum vapors and moisture. A passive system is simpler to manufacture, install and maintain and makes more sense in relatively higher and drier and cooler locations. In lower, wetter and hotter locales, though, the additional expense of an active ventilation system may be necessary.

The invention comprises a sump 1 comprising a bottom 1a, at least one sidewall 1b and a top 1c which together define an interior space 2 which can house equipment and piping for pumping and transmitting petroleum products. The sump comprises one sidewall if circular but multiple sidewalls if not circular. The invention further comprises a first pipe 3 and a second pipe 4, each of these pipes having two ends, with one end of each pipe extending through an opening in the sump to the interior space and the other end of each pipe in the atmosphere above-ground. Each of these pipes may comprise a single continuous piece or a series of segments of smaller pipes joined together, but the term “pipe” herein can refer to any configuration of pipe, whether formed from one continuous piece or segments joined together. Each pipe has a center which is a longitudinal axis spanning the length of each pipe. In one embodiment, the first pipe brings fresh air from the atmosphere into the interior space and the second pipe transmits petroleum vapors and moisture outwardly from the interior space to the atmosphere, or the direction of flow may be reversed. The first pipe comprises two ends, an interior end 3a which, in one embodiment, can terminate near the bottom of the sump in one of several ways. The interior end, for instance, extends through an opening in the sump and can terminate at the first pipe's junction with the sidewall 1b of the sump or can extend into the interior space of the sump at any other location. The first pipe 3 also comprises an exterior end 3b which terminates typically 12 feet (3.6 meters) above the ground at a retail location. The second pipe 4 comprises an inside end 4a which extends through an opening to the interior space in one of several ways, either terminating at the junction with the sidewall 1b of the sump or extending further into the interior space of the sump. The inside end of the second pipe, in one embodiment, may be positioned vertically above the interior end 3a of the first pipe 3, or vice versa. The outside end 4b of the second pipe, in one embodiment, is located 12 feet (3.6 meters) above the ground at a retail location. The center of the interior end 3a of the first pipe, in one embodiment, is no more than 18 inches from the bottom 1a of the sump. The center of the inside end 4a of the second pipe, in one embodiment, is not more than three feet from the top 1c of the sump.

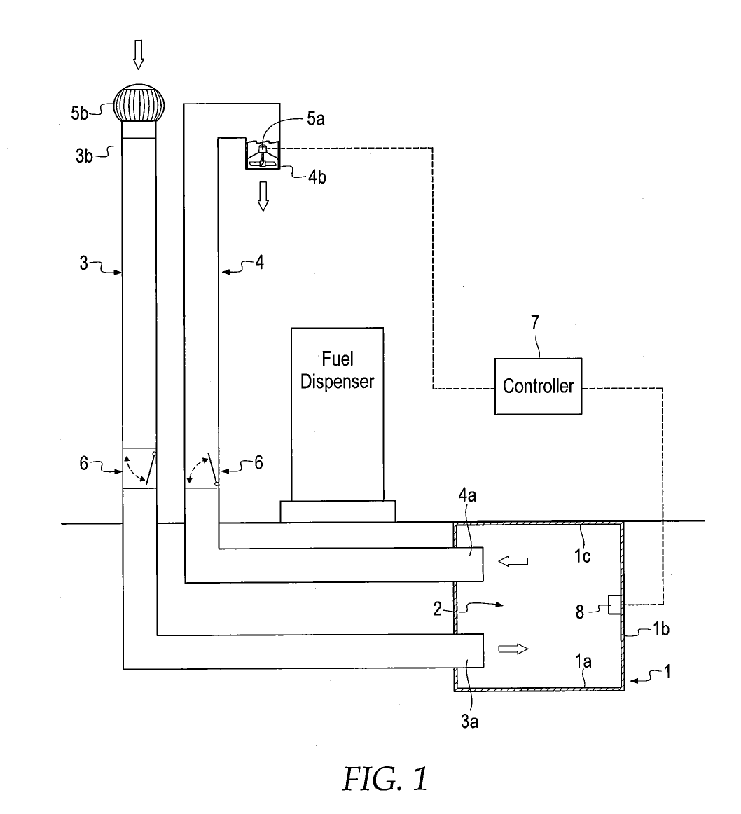

Additional means enable the active ventilation embodiments of the invention, as set for below. Active ventilation can be achieved in one of several embodiments comprising a ventilation element 5 which can comprise a fan 5a or air pump (not shown) driven by a power source from an electrical connection, as in FIG. 1. In another embodiment the ventilation element may comprise a turbine 5b driven by wind connected to at least one of the exterior end of the first pipe or the outside end of the second pipe. The ventilation element can be employed to pull fresh air into the interior space of the sump and, in one or more of these embodiments, the ventilation element is positioned near the exterior end 3b of the first pipe which is above ground. Or, conversely, the ventilation element can be positioned near the outside end 4b of the second pipe so that the ventilation element can move petroleum vapors from the interior space to the atmosphere. In yet another embodiment, the at least one ventilation element can be located at any location along the length of at least one of the first pipe and the second pipe. The system can employ one ventilation element in or near the end of at least one of the first pipe and the second pipe.

The ventilation element, in one embodiment, is driven by a controller 7 which enables a person who is operating the system (“the operator”) to drive the ventilation element at any time of the operator's choosing, or at times set by the operator selecting pre-set or manually set cycles or other conditions for operating the ventilation element. The controller may comprise programmable modules for timing of operation of the ventilation element, or for setting values for the monitors, i.e., setting thresholds for activation or deactivation of the ventilation element. The controller may be incorporated into a tank monitor such as the TLS-350 Plus or TLS-450 Plus by Veeder-Root or the TS-550 evo and TS-5000 evo by Franklin Fueling Systems.

FIG. 1 depicts an embodiment of active ventilation for the ventilation system with a wind-driven turbine 5b on the exterior end 3b of the first pipe 3 fan 5a on the outside end of the second pipe 4. This figure also depicts a system in which the flow of air, petroleum vapors and moisture is uni-directional, as show by the four arrows, as a result of two or more valves 6 positioned within or adjacent to the first and second pipes. In FIG. 1 two valves are depicted schematically in the open position 6a. Uni-directional flow may also be achieved by using only one valve. The passive embodiment would not require any ventilation element 5a, 5b. The active ventilation embodiment could be converted to a passive ventilation embodiment by removing or disabling the ventilation elements 5a, 5b, as shown in FIG. 1. The uni-directional embodiment could be converted to a bi-directional embodiment by removing or disabling all of the valves 6 from the system, as shown in FIG. 1 and by removing or disabling the ventilation elements.

In one embodiment, the controller communicates with at least one monitor 8 positioned at an advantageous location in the interior space of the sump, so that the ventilation element is driven by the controller only when pre-set values registered by the monitors are met or exceeded. A circuit between the monitor, the controller and the ventilation element allows the ventilation element to operate only when there is a need. The monitors may be electrical, electrochemical, optical, or flotational and these have been previously described elsewhere, for example in Sabo, et al. US 2014/0053943, which is incorporated herein by reference in its entirety. The flotational monitor sends a shut off signal to the ventilation element when the fluid level (water or petroleum) is too high and the system should be shut down.

The first pipe and second pipe in the embodiment for passive ventilation may be configured so that either may transmit fresh air into the sump or tale petroleum vapor and moisture from the sump. That is, atmospheric conditions outside above-ground or micro-climatic conditions in the interior space of the sump allow the first pipe to be an intake for fresh air and the second pipe to be an exhaust for petroleum vapors and moisture, or vice-versa. As such, the movement on the one hand of fresh air or petroleum vapors and moisture on the other hand will force movement of the other in the opposite direction. That is, the system can switch directions based upon conditions inside and outside the system.

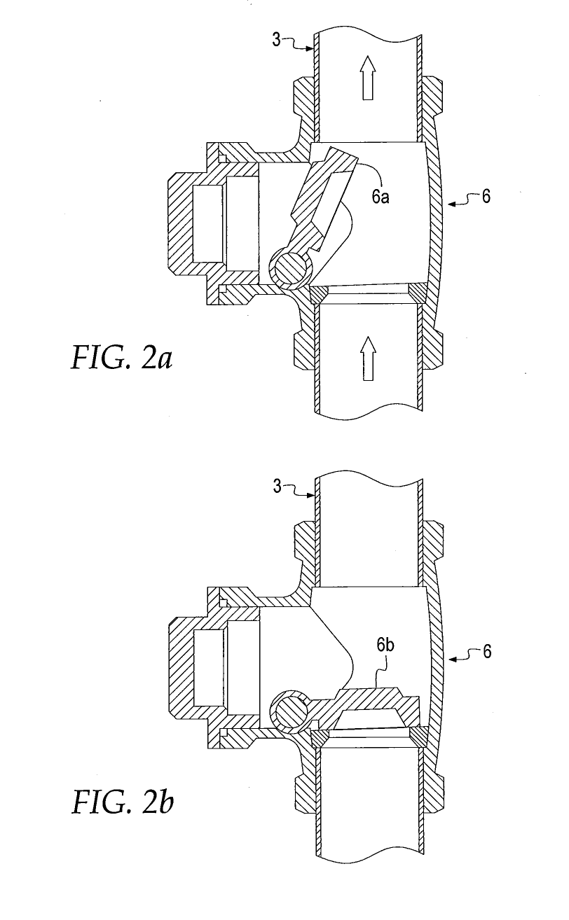

In one embodiment, a valve 6 can be positioned inside at least one of the first pipe and the second pipe so that the flow of fresh air, petroleum vapors and moisture can go in only one direction in either a passive or active ventilation embodiment. The valve can be configured so that flow of fresh air, petroleum vapors and moisture can be in either direction, but not both at the same time, within the first and second pipes. An example of a suitable valve is the Series 246 by Morrison Brothers. As depicted in FIGS. 2a and 2b, each valve has an open position 6a allowing flow in one direction and also a closed position 6b which prevents flow in the opposite direction. The direction of flow can be reversed in another embodiment by reversing the orientation of the at least one valve. In FIG. 1 the valves are located near ground level for convenient access, but they may be located anywhere within the first pipe and the second Pipe.

1. A ventilation system for a petroleum containment sump, comprising
a. a petroleum containment sump comprising a bottom, at least one sidewall, a top, an interior space and at least two openings,
b. a first pipe comprising an interior end and an exterior end, said interior end extending through one of the openings to the interior space and said exterior end being above ground and opening air,
c. a second pipe comprising an inside end and an outside end, said inside end extending through one of the openings to the interior space and said outside end being above ground and opening to fresh air,
such that fresh air enters the petroleum containment sump through one of the pipes and petroleum vapors and moisture exit the sump through the other pipe, thereby preventing or retarding corrosion of metal components inside the petroleum containment sump.

2. The ventilation system as in claim 1 wherein the interior end of the first pipe has a center which is 18 inches or less from the bottom of the petroleum containment sump.

3. The ventilation system as in claim 1, wherein the inside end of the second pipe has a center which is 36 inches or less from the top of the petroleum containment sump.

4. The ventilation system as in claim 1, wherein the center of the interior end of the first pipe is closer to the bottom of the petroleum containment sump than is the center of the inside end of the second pipe.

5. The ventilation system as in claim 1, further comprising at least one ventilation element affixed to at least one of the first pipe and the second pipe, a controller, and at least one monitor in the interior space, said at least one ventilation element, said controller and said at least one monitor communicating together.

6. The ventilation system as in claim 5, wherein the at least one ventilation element is located near at least one of the exterior end of the first pipe and the outside end of the second pipe.

7. The ventilation system as in claim 5, wherein the at least one monitor comprises an optical monitor.

8. The ventilation system as in claim 5, wherein the at least one monitor comprises an electrical monitor.

9. The ventilation system as in claim 5, wherein the at least one monitor comprises an electrochemical monitor.

10. The ventilation system as in claim 5, wherein the at least one monitor comprises a flotational monitor.

11. (canceled)

12. (canceled)

13. The ventilation system as in claim 5, wherein the controller is programmable by an operator.

14. The ventilation system as in claim 5, wherein the controller is programmable for timing of operation of the at least one ventilation element.

15. The ventilation system as in claim 5, wherein the controller is programmable for setting values for the at least one monitor.

16. The ventilation system as in claim 5, wherein the at least one ventilation element is a turbine driven by wind.

17. The ventilation system as in claim 5, wherein the at least one ventilation element is a fan connected to a power source.

18. The ventilation system as in claim 5, wherein the at least one ventilation element is an air pump connected to a power source.

19. The ventilation system as in claim 1, further comprising a valve inside at least one of the first pipe and the second pipe which restricts the flow of fresh air, petroleum vapors and moisture to one direction.

20. The ventilation system as in claim 1, wherein the flow of fresh air, petroleum vapors and moisture may alternate in one of two directions.

21. The ventilation system as in claim 5, wherein the controller is capable of driving the at least one ventilation element upon a threshold value being detected by the at least one monitor.

22. The ventilation system as in claim 1, wherein the petroleum containment sump is a submersible turbine sump.
